(19) United States
(12) Patent Application Publication
(10) Pub. No.: US 2013/0325853 A1
(43) Pub. Date: Dec. 5, 2013

(54) DIGITAL MEDIA PLAYERS COMPRISING A MUSIC-SPEECH DISCRIMINATION FUNCTION

(71) Applicant: Jeffery David Frazier, (US)

(72) Inventor: Jeffery David Frazier, Portola Valley, CA (US)

(73) Assignee: Jeffery David Frazier, Portola Valley, CA (US)

(21) Appl. No.: 13/764,598

(22) Filed: Feb. 11, 2013

Related U.S. Application Data
(60) Provisional application No. 61/652,822, filed on May 29, 2012.

(51) Int. Cl. G06F 17/30

(52) U.S. Cl. CPC G06F 17/30029
USPC 707/723; 707/754; 707/722; 707/749

(57) ABSTRACT

Embodiments are described for the discrimination of media files to be played by a digital media player, so that non-music or speech files can be filtered, ignored, tagged, or removed, leaving only desired files such as music files that will get played. Other non-desired files (e.g., video files) can be filtered, ignored, tagged, or removed, as well. In various embodiments, duplicate files can be filtered, ignored, tagged, or removed from the media files to be played by the digital media player. The resulting music files can be played as desired by a user, for example, in continuous or random play mode.

### CROSS-REFERENCE TO RELATED APPLICATIONS

This application claims the benefit of priority from U.S. Provisional Patent Application No. 61/652,822 filed May 29, 2012, incorporated herein by reference.

### FIELD

The present teachings relate to the field of digital music, and digital media players for playing music tracks from collections comprising multimedia files of various types.

### INTRODUCTION

Digital media players are in wide use. In the context of software, media players typically allow users to, for example, organize their multimedia collection, play songs, audiobooks, podcasts, and movies, rip CD tracks to MP3 and other audio formats, burn CDs and DVDs, listen to internet radio and download content via file sharing and online music stores. In the context of hardware or “physical” media players, these typically comprise, for example, hardware that plays audio and video content. When referring to equipment, the term media player is very generic and may refer to a variety of devices.

Well known software media players include, for example the following software media players: ITUNES®, WINDOWS® MEDIA PLAYER, VLC MEDIA PLAYER®, REALPLAYER®, DIVX PLAYER®, KANTARIS™, MIRO™, among other media players. Physical players include the following physical media players: APPLE IPOD®, CREATIVE ZEN®, MICROSOFT ZUNE®, among other physical media players. Typically, such players allow a user to create a desired “playlist.” Playlists are one's own custom groupings of media clips that the player will play in sequence. They can be any combination of media clips, whether they're on a computer, on a local network, on a memory stick, or out on the internet (e.g., in the cloud). Playlists take up very little space on one's hard drive, because each is simply a list of shortcuts to pertinent media files.

Shuffle Play will randomize the playback of a playlist. Continuous Play will play a playlist and return to the beginning to cycle through again when it reaches the end.

Many people have collections of media that include music as well as audiobooks and other “spoken word” or “speech” media. Oftentimes it may be desirable to use continuous play mode or shuffle play mode on an entire media collection or a substantial portion of it (e.g., a DVD or SD card comprising gigabytes of media files), in order to listen to music for a substantial period of time. Manually selecting each and every media file individually may not be desirable or feasible, so no human filtering of files takes place. In such instances, upon playing the files, several songs may play, as desired, but then a selection from an audiobook may play, which is not desired.

There is a need for a digital media player that, alone or in combination with ancillary hardware/software, can discriminate between music files and non-music files, in order that non-music files can be filtered out, removed, tagged, or ignored and only music files played.

### SUMMARY

A non-limiting summary of various aspects of the present teachings, in accordance with various embodiments, is provided next.

The present teachings provide, among other things, for the discrimination of media files to be played by a digital media player, so that non-music or “spoken word” files can be filtered, ignored, or removed, leaving only or substantially only desired files such as music files that will get played. Other non-desired files (e.g., video) can be filtered out, ignored, or removed, as well. In various embodiments, like or substantially similar (duplicate) files can be filtered, ignored, or removed from the media files to be played by the digital media player. The resulting music files can be played as desired, for example, in continuous or random mode.

In various embodiments, it is contemplated that it may be desired to have the music in audio soundtracks of video files in a collection of media files played (or included on a playlist for playing). In such embodiments, it can be desirable not to filter, ignore, or remove those video files or musical portions thereof.

In an exemplary, non-limiting aspect, methods are provided for the discrimination of media files to be played by a digital media player, so that non-music or “spoken word” files can be filtered out, ignored, tagged, or removed, leaving only or substantially only desired files such as music files that will get played. In various embodiments, the methods can comprise: (i) providing a collection comprised of a plurality of files, with a first set of the files comprised of music files and a second set of the files comprised of non-music files; (ii) analyzing one or more files of the plurality of files to determine which files are non-music files and, optionally, which files are music files; (iii) filtering the non-music files; and, (iv) playing two or more of the music files, from those determined to be music files, on a digital media player, and not playing the non-music files. The music files can be played as desired, for example, in continuous or random mode.

In various embodiments, the method further comprises the step of: generating a playlist consisting essentially of the music files; generating a playlist consisting of the music files; generating a playlist comprised substantially of the music files; generating a playlist having substantially only music files; or, generating a playlist having only music files.

According to various embodiments, the non-music files can include, among other things, audiobooks, lectures, movies, or podcasts.

In various embodiments, step (ii) is automatically carried out, at least in part, by machine-readable computer code embodied as a plugin adapted to interface with and extend the capabilities of a software digital media player.

In a variety of embodiments, step (ii) is automatically carried out, at least in part, by machine-readable computer code embodied as firmware of a physical digital media player.

According to various embodiments, the method further comprises the step of detecting plural substantially similar or like music files (referred to generally herein as, “duplicates”) in the collection and selecting only one of the plural substantially similar or like files, or duplicates, to be played in step (iv). In various embodiments, the degree of similarity or likeness can be selectable by a user. For example, in various embodiments, a selectable likeness threshold above which duplicates will be played can be at least 70% likeness, at least 80% likeness, at least 90% likeness, at least 95% likeness, or at least 98% likeness.

Various embodiments of the present teachings provide a method for the discrimination of media files to be played by a digital media player, so that non-music or speech files can be filtered, tagged, removed, or ignored, leaving substantially only desired files such as music files that will be played. According to various embodiments, the method comprises: (i) providing a collection comprising a plurality of mixed file types, including a first set of file types comprised of music files and a second set of file types comprised of non-music files; (ii) analyzing one or more files of the plurality of file types to determine which files are music files and which files are non-music files; (iii) generating a playlist consisting of, or essentially of, the music files; and, (iv) playing a plurality of the music files, selected from the playlist, on a digital media player.

In various embodiments, the non-music files can include, for example, audiobooks, lectures, movies, podcasts, etc.

According to various embodiments, step (ii) is automatically carried out, at least in part, by machine-readable computer code embodied as a plugin adapted to interface with and extend the capabilities of a software digital media player.

In accordance with various embodiments, step (ii) is automatically carried out, at least in part, by machine-readable computer code embodied as firmware of a physical digital media player.

In various embodiments, the method further comprises the step of detecting two or more similar or like music files in the collection and selecting only one of the two or more similar or like files to be played in step (iv). According to various embodiments, the degree of, or percent, similarity or likeness is selectable by a user.

Various embodiments of the present teachings provide a program product embodying a set of instructions executable by a processing device for performing a method for the discrimination of media files to be played by a digital media player, so that non-music or speech files can be filtered, removed, tagged, or ignored, leaving substantially only desired files such as music files that will be played. In various embodiments, the method comprises: (i) analyzing plural files of a plurality of file types to determine which files are music files and which files are non-music files; and, (ii) playing a plurality of the music files, from those determined to be music files, on a digital media player, and filtering the non-music files.

According to various embodiments, filtering can comprise excluding subject files (i.e., filtered files) from consideration for playing and/or for inclusion on a playlist. Filtered files, in accordance with various embodiments of the present teachings, will typically be non-music files. Filtered files may also comprise files tagged in associated metadata as non-music files.

According to various embodiments, tagging can comprise annotating metadata associated with a subject file (for example, an ID3 metadata container as is often used in conjunction with MP3 audio files).

In various embodiments, the method further comprises the step of determining substantially similar or like music files (duplicates), and the filtering step further comprises filtering duplicates.

According to various embodiments, the method further comprises the step of generating a playlist comprised substantially of, consisting of, or consisting essentially of, the music files. In various embodiments, the music files of the generated playlist comprise unique music files.

Various embodiments of the present teachings provide a digital audio player comprising (i) a file reader adapted to read multimedia files from a collection comprising a plurality of mixed file types, including a first set of file types comprised of music files and a second set of file types comprised of non-music files; (ii) a multimedia file analyzer that distinguishes between music files and non-music files; (iii) a playlist generator configured to generate a playlist comprised substantially of, consisting of, or consisting essentially of, music files; and, (iv) a player adapted to play entries from the playlist.

In various embodiments, the file reader can be an audio/video file reader, such as a CD player, DVD player, MP3 player, hard drive, smart phone, disk drive, card reader, or the like. In various embodiments, the file reader can comprise an audio file reader. The file reader can be coupled to a decoder for decoding encoded files, such as MP3 and WMA files, etc.

In accordance with various embodiments, the digital audio player can comprise a software digital audio player. In various embodiments, the player can further comprise a plugin interfacing with the player, wherein the plugin comprises machine-readable computer code for distinguishing between speech and music.

In accordance with various embodiments, the digital audio player can comprise a physical digital audio player. In various embodiments, the player can further comprise a chip or chips in the player including firmware, wherein the firmware includes machine-readable computer code for distinguishing between speech and music.

According to various embodiments, the digital audio player can further comprise a duplicate detector that determines like or substantially similar music files, and the playlist generator can be configured to generate a playlist consisting of, or essentially of, unique music files (i.e., a playlist consisting of, or consisting essentially of, music files without, or substantially without, duplicates).

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 shows a multimedia-enabled, mobile phone communicating with a remote server comprising part of a communications network, according to various embodiments of the present teachings;

FIG. 2 is a flow chart that illustrates the steps of an exemplary method for playing non-duplicative musical tracks from a repository of both music and non-music files, according to various embodiments of the present teachings; and,

FIG. 3 is a block diagram of software for implementing a music-speech discrimination feature and duplicate detection feature, in accordance with various embodiments of the present teachings.

### DESCRIPTION

Reference will now be made to various embodiments. While the present teachings will be described in conjunction with various embodiments, it will be understood that they are not intended to limit the present teachings to those embodiments. On the contrary, the present teachings are intended to cover various alternatives, modifications, and equivalents, as will be appreciated by those of skill in the art.

The present teachings provide, among other things, a speech-music discrimination function for a digital media player for the discrimination of media files to be played by the digital media player, so that non-music or “spoken word” files can be filtered, ignored, tagged, or removed, leaving only desired files such as music files that will populate a playlist and get played. Other non-desired files (e.g., video) may be filtered out, ignored, tagged, or removed, as well. The digital media player can include various play modes that are selectable by a user, such as continuous and random play.

In various aspects, the present teachings provide for one or more operations upon a collection comprising a plurality of files, such as multimedia files. Among the plurality of files are files that are desired to be played by way of a digital media player, such as music files, and potentially undesirable files for playing by way of the digital media player, such as non-music files, e.g., audiobooks, podcasts, lectures, videos, and/or other speech or spoken-word files.

Among the one or more operations, an analysis step can be performed on one or more files of the plurality of files. According to various embodiments, analysis can include, for example, determining whether a file of the plurality of files is a music, or audio, file or not. For example, various embodiments contemplate analyzing one or more files of a plurality of files to determine (a) which files are non-music files and, optionally, which files are music files, or (b) which files are music files and, optionally, which files are non-music files. In various embodiments, analysis can further include, for example, a determination of whether any two or more files of the plurality of files are alike or substantially similar (i.e., duplicates).

The analysis step can be performed before a file is added to the collection, at the time a file is added to the collection, and/or after a file has been added to the collection. The analysis step can take place while the digital media player is not in active use (e.g., is idle, running in the background) and/or during use (e.g., on-the-fly). Analysis can occur no more than once for each file of the plurality of files and the results stored for later retrieval as needed, or it can be performed plural times, such as every time a file is considered to be played by way of the digital media player. In various embodiments, it is contemplated to read ahead; that is, analyze the next track to be played (as opposed to a then-currently playing music track) and check to see if it is a music track. If it is, then it can be played next. If it is not, then a next track can be analyzed, and so forth. In some embodiments, a track is analyzed as it is accessed for playing, and it can be played if it is music; or it can be skipped if it is not music, in which case a next track can then be analyzed. This process can be repeated.

Further among the one or more operations, a classification step can be performed on one or more files of the plurality of files. The classification step can classify various of the files according to a desired classification scheme. For example, a scheme can provide for classification of files as “music” files or “non-music” files, or the like.

Still further among the one or more operations, a playlist discrimination step can be performed on one or more files of the plurality of files. For example, if a file is classified as “music,” then the file can be designated to be played, while “non-music” files will designated (directly or indirectly) not to be played.

Another operation among the one or more operations provides for playing of plural music files or tracks only, from the plurality of files.

Music files can be played as desired (e.g., as selected by a user), for example, in continuous or random mode.

In an exemplary, non-limiting aspect, methods are provided for the discrimination of media files to be played by a digital media player, so that non-music or “spoken word” files can be filtered out or ignored, leaving only desired files such as music files that will get played. In various embodiments, the methods can comprise: (i) providing a collection comprised of a plurality of mixed multimedia file types, including a first set of the files comprised of music files and a second set of the files comprised of non-music files; (ii) analyzing one or more files of the plurality of files to determine (a) which files are non-music files and, optionally, which files are music files, or (b) which files are music files and, optionally, which files are non-music files; and, (iii) playing two or more of the music files (e.g., in sequence) on a digital media player, and not playing the non-music files. Music files can be played as desired, for example, in continuous or random mode.

It is noted, in various embodiments, that a function (e.g., a subset of the player) within the media player can filter files. In some embodiments, one or more of the operations described herein can be provided in the form of a plug-in for one or more digital media players.

A plug-in is a bundle that adds functionality to an application, called the host application, through some defined architecture for extensibility. This allows third-party developers to add functionality to a device or an application without having access to the source code. This also allows users to add new features to an application just by installing a new bundle in the appropriate folder. Screen saver modules, preference panes, Interface Builder palettes, ADOBE PHOTOSHOP® graphics filters, and ITUNES® music visualizers are examples of plug-ins. One can use them whenever one wants to add an instance or multiple instances of a particular type of module that provides a well-defined unit of functionality, such as a new export filter in a graphics program, a new transition style in a video editing program, or other type of feature. Apple, Inc. provides information concerning plug-in architectures in the Mac Developer Library, Introduction to Dynamically Loading Code, Plug-in Architectures; Apple, Inc., copyright 2003, 2007; incorporated herein by reference.

In a variety of embodiments, one or more of the operations described herein can be provided in the form of an app designed to run on the operating system of one or more digital media players, e.g., on a mobile computing device running the APPLE® iOS, ANDROID™, WINDOWS® Mobile, SYMBIAN®, RIM, PALM™, or other operating system.

In various embodiments, the speech-music discriminator is implemented through a software macro for a digital music player. In some embodiments, for example, the software macro can be downloaded into an existing digital music player.

In further embodiments, one or more of the operations described herein can be directly coded into a digital media player. In some embodiments, code embodying one or more of the operations herein is embedded in a chip that is the original chip of a digital media player. In various embodiments, code embodying one or more of the operations herein is embedded in a chip that can replace or “upgrade” an existing chip of a digital media player.

Those skilled in the art can code the functions, operations, method steps, and such taught herein for use with a variety of digital media players.

Software media players include, for example, the following software media players: ITUNES®, WINDOWS® Media Player, VLC MEDIA PLAYER®, REALPLAYER®, DIVX PLAYER®, KANTARIS™, MIRO™, among other media players. Physical players include the following physical media players: APPLE IPOD®, APPLE IPHONE®, CREATIVE ZEN®, MICROSOFT ZUNE®, SAMSUNG GALAXY® SIII, among other physical media players. It should be noted, the present teachings contemplate any general purpose device or machine that is programmable such that it can perform the functions/actions of a typical media player and can embody one or more of the present teachings.

Whether software or physical, digital media players can be adapted to play any one or more of a wide variety of audio formats, including without limitation way, aif, mp3, wma, flac, among others. (See, e.g., FileInfo.com; and, “Creating Digital Music and Sound: An inspirational introduction for musicians, web designers, animators, videomakers, and game designers” by Chris Middleton, Focal Press (Jun. 16, 2006); each incorporated herein by reference).

In various embodiments, a music-speech discriminator is employed for distinguishing music and speech. A variety of tools, algorithms, and approaches for distinguishing music and speech are known in the art, and like or similar means can be employed herein. See, for example, Speech/Music Discrimination Using Discrete Hidden Markov Models, Karneback, S., TMH-QPSR, volume 46, number 1, 2004, pages 041-059; Automatic speech/music discrimination in audio files, Lars Ericsson, Master's thesis in Music Acoustics at the School of Media Technology Royal Institute of Technology, 2009; A Fast and Robust Speech/Music Discrimination Approach, W. Q. Wang, W. Gao, D. W. Ying, ICICS-PCM 2003, 15-18 Dec. 2003, Singapore, pages 1-5; Speech and Music Discrimination based on Signal Modulation Spectrum, Pavel Balabko, Jun. 24, 1999; Frame-Level Speech/Music Discrimination using AdaBoost, Norman Casagrande, Douglas Eck, Balázs Kégl; GEOMETRY IN SOUND: A SPEECH/MUSIC AUDIO CLASSIFIER INSPIRED BY AN IMAGE CLASSIFIER, University of Montreal, Department of Computer Science, N. Casagran, D. Eck, B. Kegl; Speech/music discrimination based on posterior probability features, Poster, Gethin Williams, Department of Computer Science, University of Sheffield, UK, g.williams@dcs.shef.ac.uk, Dan Ellis, International Computer Science Institute, Berkeley Calif. USA, dpwe@icsi.berkeley.edu, for EUROSPEECH'99 Budapest, 1999 Aug. 17; U.S. Pat. No. 6,785,645; WO 1998/027543; U.S. Pat. No. 5,712,953; and U.S. Pat. No. 7,179,980; each of which is incorporated by reference herein. Other means for distinguishing music and speech can be used, as well.

According to various embodiments, a digital media player is provided, including means for performing plural of the operations described herein. The digital media player can be adapted for use with a computer, such as one running the Windows, Mac, or Linux operating system. Files of a collection of files can be analyzed in the background, whether the player is operating or not, and each individual file can be designated as being a “music” file or a “non-music” file. Upon receiving an input request from a user to play music (songs) in a random order from the collection, the player generates a temporary, random playlist comprised substantially only of music files. The player then plays the music files, one after another, from the randomly generated playlist.

According to various embodiments, the present teachings can be employed with a remote source of files, such as a database or repository comprising music and other files, and a local digital media player. The local digital media player can be configured, for example, to receive wired and/or wireless streaming media originating from the database or repository (and, optionally, one or more other sources). In various embodiments, the player comprises a media-capable phone adapted to receive streaming media over 2G, 3G and/or 4G networks, as well as over Wi-Fi or other networks. For example, the phone can comprise an APPLE® IPHONE®. In a variety of embodiments, the digital media player downloads and samples part of the streamed file and determines whether the content is music or non-music before playing it. If the content is music, then the player plays it. If the content is not music, e.g., it is an audiobook, then the player does not play the streamed file, but instead requests that another file be streamed from the database or repository to be analyzed and, if it is music, played.

In various embodiments, various aspects of the present teachings provide for the removal or tagging of duplicate music files from a plurality of music files, as by a duplicate remover or tagger. Duplicates can be identical files, or substantially similar files. For example, an approach can be employed that determines whether two music files are identical. As an alternative, or in addition, an approach can be employed that uses a fuzzy approach to determine whether two files are substantially similar. In some embodiments, a user can select any position along a continuum from identical to similar, to select the degree of identity and/or fuzziness that will be utilized. In various embodiments, a duplicate song finder function, according to the present teachings, can provide a list of likely duplicates, and offer a user options for the files, such as filtering, ignoring, tagging, playing, deleting, or moving the files. (See, e.g., Duplicate Song Detection using Audio Fingerprinting for Consumer Electronics Devices, Consumer Electronics, 2006. ISCE '06. 2006 IEEE Tenth International Symposium, Sinitsyn, A., Philips Res., Eindhoven, Page(s): 1-6; incorporated herein by reference). The software app SIMILARITY™ (GAR Software) provides a mechanism of searching duplicates based both on a tag comparison method and on algorithms of acoustic fingerprint.

Various tools, algorithms, and approaches are known in the art for determining similarity between songs in music files. (See, e.g., Effective and Efficient Melody-Matching Method in a Large-Scale Music Database, Sung-Phil Heo, Lecture Notes in Computer Science, 2004, Volume 3292, On the Move to Meaningful Internet Systems 2004: OTM 2004 Workshops, Pages 32-33; Alisa Rata Stutzbach. “MusicBrainz (review).” Notes 68.1 (2011): 147-151. Project MUSE. Web. 29 May 2012; Wang, A. An industrial-strength audio search algorithm. In Proceedings of the Fourth International Conference on Music Information Retrieval pp. 7-13 (Baltimore, Oct. 26-30, 2003); each incorporated herein by reference).

In various embodiments, music versus non-music files and/or duplicates are determined by metadata, i.e., the extra information that defines the contents of a file. For example, a program can be employed that can match songs with the same title and by the same artist. This approach can be particularly beneficial, for example, in situations where the integrity of the metadata is known to be of high quality.

In a variety of embodiments, an open source suite of tools such as Echoprint (Echo Nest) can be employed as a music fingerprinting and identification system. A fingerprinting system such as Echoprint can recognize music based upon what the music sounds like. In general, it does not matter what bit rate, codec or compression rate was used (up to a point) to create a music file, nor does it matter if incomplete or incorrect metadata has been attached to a music file, if the music sounds the same, the music fingerprinter will recognize that. In various embodiments, a variety of apps can be created using a music fingerprinter such as Echoprint.

Echoprint, like many music identification services comprises a multi-step process: code generation, ingestion and lookup. In the code generation step, musical features are extracted from audio and encoded into a string of characters, such as text. In the ingestion step, codes for all songs in a collection are generated and added to a searchable database. In the lookup step, the codegen string is generated for an unknown bit of audio and is used as a fuzzy query to the database of previously ingested codes. If a suitably high-scoring match is found, the information associated with the matching track is returned.

In a variety of embodiments, a function for detecting duplicates, e.g., a duplicate detector, is employed in order to produce a playlist wherein each song appears substantially only once. Depending upon the strictness of identity employed in determining duplicates, which can be selectable by a user, different versions of a song can be determined (e.g., studio versus live versions) so that substantially only one of them will be present in the playlist. It can be desirable in various situations to combine such a duplicate detection and song selection function with the previously described speech-music discrimination function for the discrimination of media files to be played by a digital media player, so that non-music or “spoken word” files can be filtered out or ignored, leaving only desired files such as music files that will populate a playlist and get played. In this way, a playlist can be generated comprised only of music files, with each song appearing substantially only once in the playlist. If desired, multiple versions of a song may be permitted to at least partially populate a playlist (e.g., live and studio versions of a song).

In various embodiments, a web-based app or local app, not having player functionality (either hardware or software), can analyze and filter, and optionally add/edit metadata, on a cloud-based file set, or on a local file set, without directly playing the resultant processed files. In various embodiments, such a web-based or local app can prepare a playlist comprised of unique music files. The playlist can be provided to an existing hardware or software player. Alternatively, or in addition, a plugin can be used in combination with a player that reads metadata which has been preset by a separate app (e.g., a web-based or local app). For example, a thin-app plugin for a software player can utilize metadata generated with a larger cloud-based or local app not having player functionality.

Various non-limiting embodiments will now be described with reference to the figures.

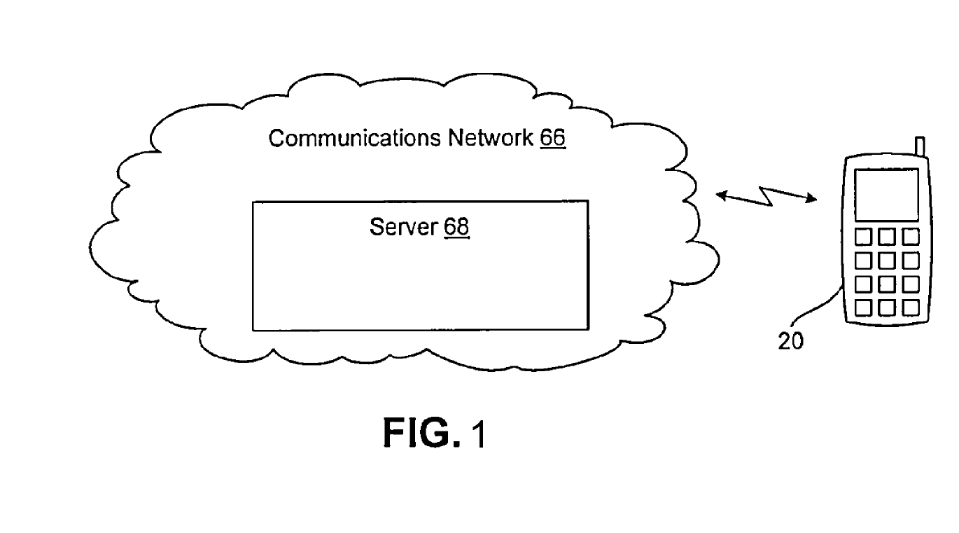

Referring now to FIG. 1, in accordance with various embodiments, a mobile phone is shown, 20, communicating with a remote server 68 comprising part of a communications network, such as 66. Communications network 66 and/or server 68 can be, for example, at least a part of an internet-connected cloud-based system. Server 68 can host a database or repository of music and non-music files. The mobile phone 20 can be multimedia enabled, which can include a digital media player for playing local or remote media files. In the depicted embodiment, music and non-music files can be streamed from the remote server 68 to the phone 20, for playing via the digital media player of the phone 20. The phone 20 can further comprise a music-speech discrimination function, and optionally a duplicate detection function, as described herein. These functions can be, for example, in the form of an app. When the digital media player is active, and the music-speech discriminator function enabled, non-music files will be filtered so that the sounds heard from the phone 20 will consist of music, and not speech or spoken word. Similarly, when the duplicate detection function is enabled, duplicate files will be filtered, so that the sounds heard from the phone 20 will consist substantially of unique songs, substantially without multiple instances of a song.

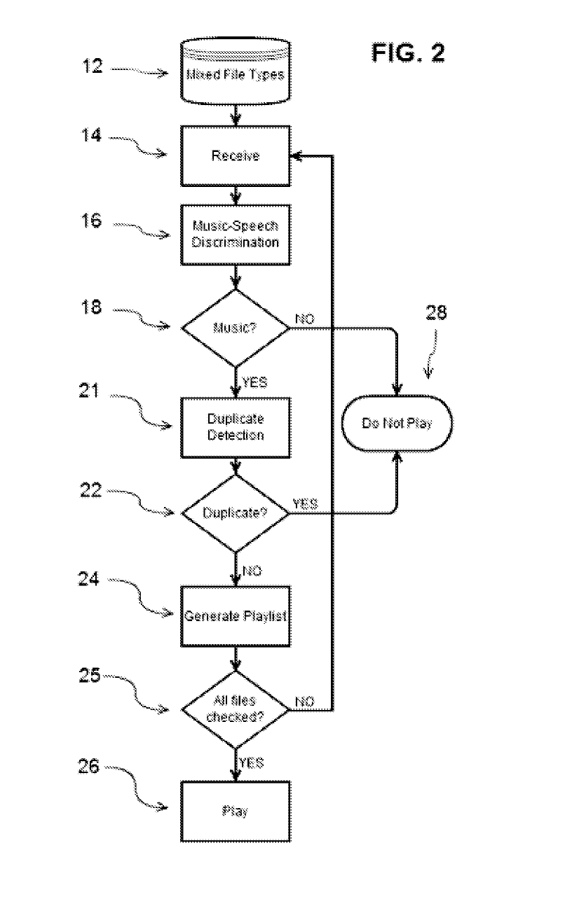

Referring now to FIG. 2, a flow chart illustrates the steps of an exemplary method for playing only non-duplicative musical tracks from a repository of both music and non-music files according to various embodiments of the present teachings. In the depicted embodiment, starting at step 14, files from a repository of mixed multimedia file types 12 are received. Each file received is analyzed at step 16 to determine if it is a music file or non-music file. Non-music files are filtered at step 18 and are not to be played. If step 18 yields a “yes,” the method proceeds to a duplicate detection step, at 21. If step 22 yields a “yes” for any given file, it is filtered and is not to be played. Non-duplicates are passed on to populate a playlist, at step 24. At step 25, it is determined if all files of the repository 12 (or, a preselected number of files or group(s) of files from the repository) have been checked. If step 25 yields a “no,” then the process returns to step 14, where another file is received. If all files have been checked at 25, the playlist comprised of non-duplicative musical tracks is then played at step 26.

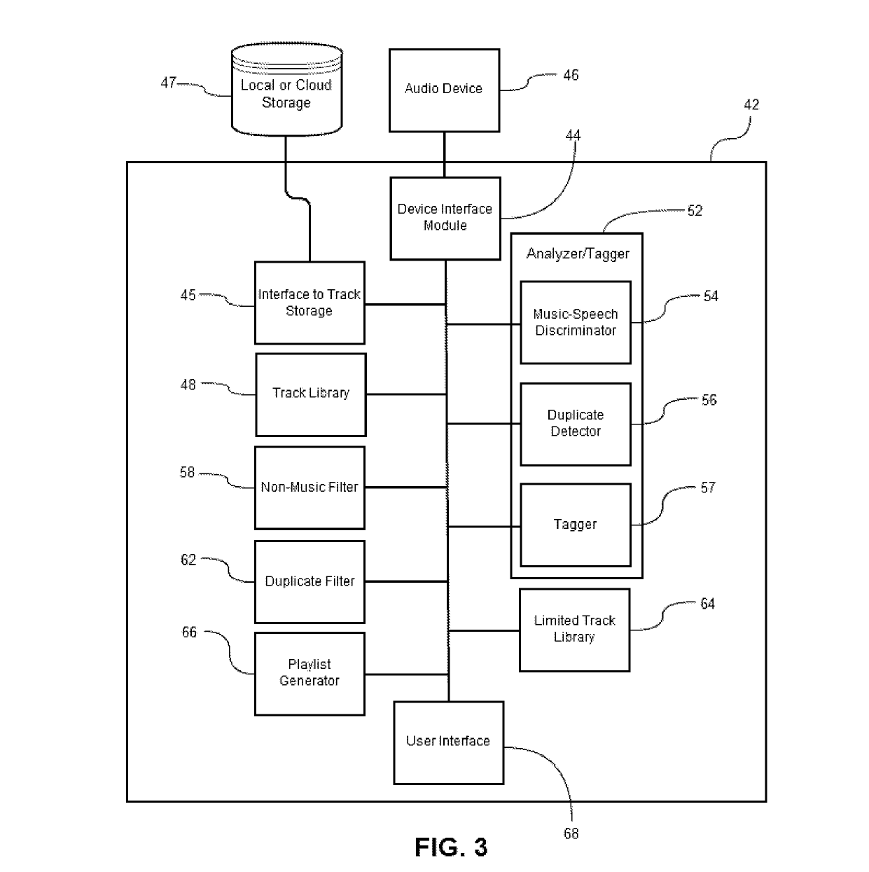

Referring now to FIG. 3, a block diagram of software 42 for implementing a music-speech discrimination feature and duplicate detection feature constructed in accordance with various embodiments of the present teachings is shown. In the depicted embodiment, the software 42 includes a device interface module 44 that allows the software 42 to communicate with a particular audio device 46 such as a designated brand of digital music player, a software media player, or an operating system of a personal computer. The software 42 can include a number of device interface modules 44 such that the software 42 can be used with a variety of different audio devices or a single device interface module 44 such that the software 42 can be utilized with a single type of audio device. An interface to track storage 45 allows the software 42 to access tracks in local, cloud, and/or other storage 47. In various embodiments, the device interface module 44 can provide an interface with local, cloud, or other storage 47 via the audio device 46. The software 42 can further include a track or song selection library 48 that can contain digital tracks, or track information, that have been compiled from a library of tracks or songs accessible by the audio device. The digital tracks can be processed by an analysis/tagging subsystem 52 comprising one or a combination of a music-speech discriminator 54, a duplicate song detector 56, and a tagger 57. Non-music tracks and duplicate tracks can be tagged as such. Filters, such as 58 and 62, filter out non-music tracks and duplicate tracks from consideration. Tracks comprising the desired criteria, music and non-duplicative, can be stored in a limited track library 64. A playlist generator function 66 can select from among the one or more tracks or songs contained in the limited track library 64 to generate a playlist. The device interface module 44 can then instruct the audio device 46 to play the selected track(s). A user interface 68 allows a user to enable the music-speech discriminator and/or the duplicate detector, and to select the percent identity/similarity allowable when the software determines duplicates. After having been processed once, the processed files can be reprocessed if/as desired (e.g., with different levels of discrimination and/or similarity).

All references set forth herein are expressly incorporated by reference in their entireties for all purposes.

Those skilled in the art can now appreciate from the foregoing description that the broad teachings herein can be implemented in a variety of forms. Therefore, while the present teachings have been described in connection with various embodiments and examples, the scope of the present teachings are not intended, and should not be construed to be, limited thereby. Various changes and modifications can be made without departing from the scope of the present teachings.

1. A method for the discrimination of media files to be played by a digital media player, so that non-music or speech files can be filtered, removed, tagged, or ignored, leaving only desired files such as music files that will be played, comprising:
(i) providing a collection comprising a plurality of mixed file types, including a first set of file types comprised of music files and a second set of file types comprised of non-music files;
(ii) analyzing one or more files of the plurality of mixed file types to determine which files are music files and which files are non-music files;
(iii) filtering the non-music files; and,
(iv) playing a plurality of the music files, from those determined to be music files, on a digital media player.

2. The method of claim 1, further comprising the step of generating a playlist comprised substantially of the music files.

3. The method of claim 1, wherein step (ii) is automatically carried out, at least in part, by machine-readable computer code embodied as a plugin adapted to interface with and extend the capabilities of a software digital media player.

4. The method of claim 1, wherein step (ii) is automatically carried out, at least in part, by machine-readable computer code embodied as firmware of a physical digital media player.

5. The method of claim 1, further comprising the step of detecting substantially similar or like music files in said collection and selecting one of the substantially similar or like files to be played in step (iv).

6. The method of claim 5, wherein the degree of similarity or likeness is selectable by a user.

7. A method for the discrimination of media files to be played by a digital media player, so that non-music or speech files can be filtered, removed, tagged, or ignored, leaving only desired files such as music files that will be played, comprising:
(i) providing a collection comprising a plurality of mixed file types, including a first set of file types comprised of music files and a second set of file types comprised of non-music files;
(ii) analyzing one or more files of the plurality of mixed file types to determine which files are music files and which files are non-music files;
(iii) generating a playlist comprised of the music files; and,
(iv) playing a plurality of the music files, selected from the playlist, on a digital media player.

8. The method of claim 7, wherein step (ii) is automatically carried out, at least in part, by machine-readable computer code embodied as a plugin adapted to interface with and extend the capabilities of a software digital media player.

9. The method of claim 7, wherein step (ii) is automatically carried out, at least in part, by machine-readable computer code embodied as firmware of a physical digital media player.

10. The method of claim 7, further comprising the step of detecting substantially similar or like music files in said collection and selecting no more than one of the similar or like files to be played in step (iv).

11. The method of claim 10, wherein the degree of similarity or likeness is selectable by a user.

12. A program product embodying a set of instructions executable by a processing device for performing a method for the discrimination of media files to be played by a digital media player, so that non-music or speech files can be filtered, removed, tagged, or ignored, leaving desired files such as music files that will be played, the method comprising:
(i) analyzing plural files of a plurality of file types to determine which files are music files and which files are non-music files; and,
(ii) playing the music files on a digital media player, and filtering the non-music files.

13. The method of claim 12, further comprising the step of generating a playlist comprised substantially of the music files.

14. The method of claim 12, further comprising the step of determining substantially similar or like music files and selecting no more than one of the similar or like music files for playing.

15. A digital audio player comprising:
a reader adapted to read files from a collection comprising a plurality of mixed file types, including a first set of file types comprised of music files and a second set of file types comprised of non-music files;
an analyzer that distinguishes between music files and non-music files;
a playlist generator for creating a playlist from the music files; and,
a player adapted to play the music files from the playlist.

16. The digital audio player of claim 15, comprising a software digital audio player.

17. The digital audio player of claim 16, further comprising a plugin interfacing with said player, wherein said plugin comprises machine-readable computer code for distinguishing between speech and music.

18. The digital audio player of claim 15, comprising a physical digital audio player.

19. The digital audio player of claim 18, further comprising a chip in said player including firmware, wherein said firmware includes machine-readable computer code for distinguishing between speech and music.

20. The digital audio player of claim 15, further comprising a duplicate detector that determines like or substantially similar music files; and wherein said playlist generator generates a playlist comprised of unique music files.
